(19) United States
(12) Patent Application Publication
(10) Pub. No.: US 2007/0103559 A1
(43) Pub. Date: May 10, 2007

(54) User-controlled security camera system for vehicles

(76) Inventor: Patricia Williams, Raleigh, NC (US)

Correspondence Address: Galasso & Associates, LP, P. O. Box 26503, Austin, TX, 78755-0503, US

(21) Appl. No.: 11/271,597

(22) Filed: Nov. 10, 2005

(51) Int. Cl. H04N 5/232

(52) U.S. Cl. 348/211.99

(57) ABSTRACT

A user-controlled security camera system for vehicles is provided to deter and record crimes involving the vehicles. The user employs a remote control device to activate and deactivate recording equipment, for example for VHS cassettes, DVDs, or any appropriate technology, that records motion pictures of an interior or exterior area of a vehicle captured by a miniature motion-picture camera. Criminals may be deterred from crimes against the vehicle by the knowledge of the presence of the security camera system. Or their images may be captured for subsequent identification by the security camera system, for example after a stolen vehicle has been recovered. The recording system is battery powered and is locked into placed by a key-operated or dialing-code-operated lock, so that criminals cannot remove the recording equipment or cassettes or tapes. In an embodiment, a wireless transmitter on the recording equipment enables wireless transmission of the captured motion-pictures to a remote receiver.

### FIELD OF THE DISCLOSURE

The present invention relates to vehicle security devices and more particularly to a user-controlled camera that monitors vehicles.

### BACKGROUND

Crimes involving vehicles, such as thefts, burglaries, vandalism, and car-jackings, can result in considerable inconvenience, damage, and serious financial loss for the owners and insurers of the vehicles. As a result, security devices have been developed to deter and record such crimes by means of video cameras that record events that happen to the vehicles.

For example, U.S. Pat. No. 5,027,104 to Reid discloses a vehicle security device that includes a multiplicity of hidden video cameras mounted in a vehicle, and designed to be activated responsive to sensing of a condition such as unauthorized entry of a vehicle or breakage. Although this system may be effective in deterring or detecting many crimes involving vehicles, the resourcefulness of criminals may enable them to take measures that would avoid triggering the sensors that initiate the video recording of a vehicle. For example, a thief may steal or create a matching key for a vehicle and enter and drive the vehicle without activating the video recording.

Therefore, there is a need for a user-controlled security camera system for vehicles that the user can start at any time and that does not require starting through sensors.

### SUMMARY OF THE DISCLOSURE

The following explanation describes the present invention by way of example and not by way of limitation.

It is an aspect of the present invention to provide a user-controlled security camera system for vehicles that the user can start at any time.

It is another aspect of the present invention to provide a user-controlled security camera system for vehicles that employs a video recording device with reusable media.

These and other aspects of the present invention will become readily apparent upon further review of the following specification and associated drawings. In accordance with the present invention, a user-controlled security camera system for vehicles is provided to deter and record crimes involving the vehicles. The user employs a remote control device to activate and deactivate recording equipment, for example for VHS cassettes, DVDs, or any appropriate technology, that records motion pictures of an interior or exterior area of a vehicle captured by a miniature motion-picture camera. Criminals may be deterred from crimes against the vehicle by the knowledge of the presence of the security camera system. Or their images may be captured for subsequent identification by the security camera system, for example after a stolen vehicle has been recovered. The recording system is battery powered and is locked into placed by a key-operated or dialing-code-operated lock, so that criminals cannot remove the recording equipment or cassettes or tapes. In an embodiment, a wireless transmitter on the recording equipment enables wireless transmission of the captured motion-pictures to a remote receiver.

### BRIEF DESCRIPTION OF THE DRAWINGS

The following embodiments of the present invention are described by way of example only, with reference to the accompanying drawings, in which:

FIG. 1 is a perspective diagram that illustrates a user-controlled security camera system for vehicles.

### DETAILED DESCRIPTION OF THE DRAWING FIGURES

The following description of drawings is offered to illustrate the present invention clearly. However, it will be apparent to those skilled in the art that the concepts of the present invention are not limited to these specific details. Also, commonly known elements are shown in diagrams for clarity, as examples only and not as limitations of the present invention.

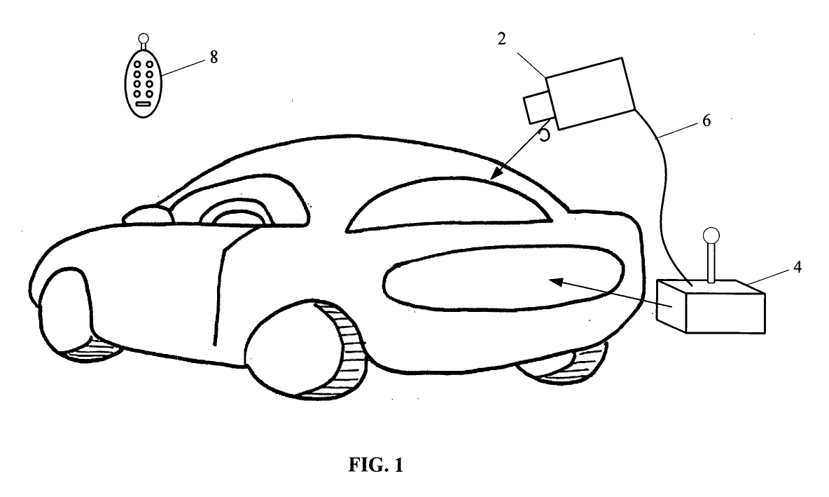

As shown in FIG. 1, the present invention is a user-controlled security camera system for vehicles, comprising the following elements:
A miniature motion-picture camera 2,
Motion-picture recording equipment 4,
Electrical wiring 6, and
A remote control device 8.
   Miniature Motion-Picture Camera

A miniature motion-picture camera 2, for example a video camera, is located in a position whereby it would be able to acquire a view of an area of a vehicle. FIG. 1 shows an embodiment where the miniature motion-picture camera 2 is attached to the rear interior section of a vehicle's roof, so that the camera 2 views the interior of the vehicle.

The miniature motion-picture camera 2 may be installed as a new vehicle feature by the manufacturer or as an after-market product installed by the vehicle's owner or operator, or by a professional in electronics equipment.

In another embodiment, the miniature motion-picture camera 2 may be placed so that it views the outside of the vehicle in close proximity.

In an embodiment, the miniature motion-picture camera 2 is visible, so that it acts as a deterrent to crime. In another embodiment, the miniature motion-picture camera 2 is hidden from view, so that criminals may be recorded unawares.

Motion-Picture Recording Equipment

The motion-picture recording equipment 4 records, onto a means of storage, the motion-picture images captured by the miniature motion-picture camera 2. Electrical wiring 6 connects the motion-picture recording equipment 4 and the miniature motion-picture camera 2. After motion-picture images have been stored, the means of storage may be removed and the images may be replayed on a player to determine the identities of any criminals who have tampered with the vehicle. The motion-picture recording equipment 4 is controlled by a remote control device 8, as explained below.

For example, the motion-picture recording equipment 4 may comprise video recording equipment for recording on reusable VHS video cassette tape that may be removed from the recording equipment 4 and played on a VHS cassette player. In other embodiments, DVD (digital video disc) or any other appropriate video recording technology, known or not yet known, may be used, as will be obvious to those skilled in the art.

The motion-picture recording equipment 4 is designed so that it can be locked into place to prevent its being removed by criminals. In an embodiment, the owner or operator of the vehicle has a key to the lock on the motion-picture recording equipment 4 and can lock the recording equipment with the key and remove the key from the lock when desired. In another embodiment, the owner or operator may set up a dialing code on the motion-picture recording equipment 4 to lock the recording equipment into place.

In still another embodiment, the motion-picture recording equipment 4 can only be removed by a certified technician, such as a technician at a car dealership. For example, the technician alone may have a key or dialing code to the lock.

In an embodiment, the motion-picture recording equipment 4 may be concealed in an inconspicuous but readily accessible location within the vehicle's passenger compartment. In another embodiment, the recording equipment may be concealed in an inconspicuous but readily accessible location within the vehicle's storage trunk, as shown in FIG. 1.

The motion-picture recording equipment 4 may be powered by batteries, for example batteries that may be recharged by the vehicle's power system.

In an embodiment, the motion-picture recording equipment 4 also comprises a wireless transmitter that allows it to transmit the video recording to a remote receiver, so that motion-pictures may be recorded on the remote receiver for live viewing or for secure storage and subsequent viewing.

Remote Control Device

A remote control device 8 is used to activate and deactivate the motion-picture recording equipment 4. Once the motion-picture recording equipment 4 is installed, it may thus be activated at any time by the vehicle's owner or operator through the remote control device 8. In an embodiment, the remote control device 8 can be located on a key ring, which the owner or operator of the vehicle can carry with him or her. In another embodiment the remote control device 8 can be a device in the owner or operator's home, office, or other location.

The best dimensional relationships for the parts of the invention described above, including variations in form and use, will be readily apparent to those skilled in the art, and are intended to be encompassed by the present invention.

Use

After a user-controlled security camera system has been installed in a vehicle, a user may employ the remote control device 8 at any time to start the motion-picture recording equipment 4 and record motion-pictures of the area of the vehicle captured by the miniature motion-picture camera 2. The miniature motion-picture camera 2 thus records a constant or intermittent view of that area of the vehicle, depending on the user's instructions.

If a crime involving the vehicle is committed, for example a burglary in the vehicle's interior, the recording can be retrieved and played back by the owner or the police, creating an electronic witness of the activity, so that the criminals may be apprehended. If the vehicle is stolen, the recording may be retrieved after the vehicle is found again. In an embodiment whereby the recording equipment 4 comprises a wireless transmitter, the recorded motion pictures are automatically transmitted to a remote receiver for live viewing or for storage and subsequent viewing.

Moreover, if the miniature motion-picture camera 2 is known to be used in a vehicle or is visible there, criminals may be deterred from attempting crimes involving that vehicle.

What is claimed is:

1. A user-controlled security camera system for vehicles, comprising
a miniature motion-picture camera, such that
the miniature motion-picture camera records motion pictures of an area of a vehicle;
means of recording the motion pictures captured by the miniature motion-picture camera, such that
the means of recording stores the motion pictures on a means of storage;
electrical wiring, such that
the electrical wiring connects the miniature motion-picture camera and
the means of recording the motion pictures; and
a remote control device, such that
a user can employ the remote control device to activate and deactivate the motion-picture recording equipment.

2. The means of recording the motion pictures of claim 1, wherein the means of recording the motion pictures comprises video recording equipment.

3. The video recording equipment of claim 3, wherein the video recording equipment comprises VHS recording equipment.

4. The video recording equipment of claim 3, wherein the video recording equipment comprises DVD recording equipment.

5. The means of storage of claim 1, where in the means of storage comprises a VHS cassette.

6. The means of storage of claim 1, where in the means of storage comprises a DVD.

7. The means of recording the motion pictures of claim 1, wherein the means of recording the motion pictures comprises at least one battery.

8. The means of recording the motion pictures of claim 1, wherein the means of recording the motion pictures is held securely in place by a means of locking.

9. The means of locking of claim 8, wherein the means of locking comprises a key-operated lock.

10. The means of locking of claim 8, wherein the means of locking comprises a lock operated by a manually dialed code.

11. The means of recording the motion pictures of claim 1, wherein the means of recording the motion pictures comprises a wireless transmitter.

12. A user-controlled security camera system for vehicles, comprising
a video camera, such that
the video camera records motion pictures of an area of a vehicle;
video recording equipment, such that the video recording equipment records the motion pictures captured by the video camera on a means of storage,
comprises at least one battery, and
is held securely in place by a means of locking;
electrical wiring, such that
the electrical wiring connects the video camera and the video recording equipment; and
a remote control device, such that
a user can employ the remote control device to activate and deactivate the motion-picture recording equipment.

13. The video recording equipment of claim 12, wherein the video recording equipment comprises VHS recording equipment that records data on a cassette.

14. The at least one battery of claim 12, wherein the at least one battery is rechargeable.

15. The means of locking of claim 12, wherein the means of locking comprises a key-operated lock.

16. The means of locking of claim 12, wherein the means of locking comprises a lock operated by a manually dialed code.

17. The means of recording the motion pictures of claim 12, wherein the means of recording the motion pictures comprises a wireless transmitter.

18. A user-controlled security camera system for vehicles, comprising
a video camera, such that
the video camera records motion pictures of an area of a vehicle;
VHS recording equipment, such that the VHS recording equipment records the motion pictures captured by the video camera onto at least one VHS cassette,
comprises at least one rechargeable battery,
is held securely in place by a means of locking, and
comprises a wireless transmitter;
electrical wiring, such that
the electrical wiring connects the video camera and the VHS cassette recording equipment; and
a remote control device, such that
the remote control device activates and deactivates the VHS cassette recording equipment.

19. The means of locking of claim 18, wherein the means of locking comprises a key-operated lock.

20. The means of locking of claim 18, wherein the means of locking comprises a lock operated by a manually dialed code.
